(19) United States
(12) Patent Application Publication
(10) Pub. No.: US 2009/0198818 A1
(43) Pub. Date: Aug. 6, 2009

(54) Terminal apparatus and recording medium on which program is recorded, as well as reconnection process method, in information distribution system

(75) Inventors: Masahiro Kamei, Nagoya-shi (JP); Yuji Kiyohara, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/320,634

(22) Filed: Jan. 30, 2009

(30) Foreign Application Priority Data
Feb. 4, 2008 (JP) 2008-024522

(51) Int. Cl. G06F 15/16

(52) U.S. Cl. 709/227

(57) ABSTRACT

To provide a terminal apparatus and a program thereof, as well as a reconnection process method, in an information distribution system which enables a swifter completion of a reconnection process in the information distribution system. The terminal apparatus includes a connection condition detection module which detects that it has become necessary to reconnect to another terminal apparatus different from an apparatus connected upstream in a hierarchical structure, a connection process module which, on detecting that the reconnection has become necessary, starts a process of connecting to another terminal apparatus configuring the hierarchical structure, a connection request module which, on detecting that the reconnection has become necessary, requests of an apparatus connected downstream a process of connecting to another terminal apparatus configuring the hierarchical structure, and a reception control module which, on the connection process of the apparatus connected downstream finishing before the connection process using the connection process module finishes, receives information with the apparatus connected downstream as an upstream apparatus.

### CROSS-REFERENCE TO RELATED APPLICATION(S)

This application is based on and claims the benefit of priority from Japanese Patent Application No. 2008-024522 filed on Feb. 4, 2008; the entire contents of which are incorporated herein by reference.

### BACKGROUND OF THE INVENTION

1. Field of the Invention

The present invention relates to a terminal apparatus and a program, as well as a reconnection process method, in an information distribution system, and in particular relates to a terminal apparatus and recording medium on which a program is recorded, as well as a reconnection process method, in an information distribution system including an information distribution apparatus, which distributes content information via a network, a plurality of terminal apparatus logically connected in multilayers on the network in a hierarchical structure, with the information distribution apparatus as an apex, and a connection management apparatus, which manages information on the hierarchical structure, wherein the content information distributed from the information distribution apparatus is sequentially relayed to downstream terminal apparatus by a relay function of the terminal apparatus.

2. Description of the Related Art

In recent years, accompanying a spread of broadband, an information distribution service which distributes content information has become popular. For example, as well as a service which distributes content information in accordance with a user's request, as with a VOD (Video On Demand), a service which distributes content information in a broadcast format, as with an internet broadcasting, has been known.

Although in this kind of information distribution service a distribution form using a server client method has been predominant, a tree-shaped topology format, which is a P2P (Peer To Peer) type of distribution form, has recently been attracting attention as a new distribution form to replace this method.

The tree-shaped topology format is a distribution form wherein a plurality of terminal apparatus are logically connected in multilayers on a network in a tree-shaped hierarchical structure, with an information distribution apparatus as an apex. The information distribution apparatus distributes content information via the network, such as an internet and content information distributed from the information distribution apparatus is sequentially relayed to downstream terminal apparatus by a relay function of the terminal apparatus (for example, refer to Japanese Unexamined Patent Publication No. 2006-33514).

### SUMMARY OF THE INVENTION

In a heretofore known tree-shaped topology format of distribution form, a terminal apparatus, in the case that a terminal apparatus connected upstream withdraws from the information distribution system, or in the case that a connection with an upstream terminal apparatus is disconnected due to a deterioration of a communication condition, or the like, looks for another terminal apparatus to which it is possible to connect, and carries out a process of reconnecting to it, but at this time, the terminal apparatus carries out the reconnection process while maintaining a tree-shaped structure (hereafter, also called a “sub-tree”) with the terminal apparatus itself as an apex. In this way, with the heretofore known information distribution system, as only a terminal apparatus (a terminal apparatus positioned at an apex of a sub-tree) which has been directly connected to a terminal apparatus which has withdrawn from the system carries out the reconnection process, it is possible to prevent an enormous burden imposed on the system due to all other terminal apparatus connected to the downstream of the terminal apparatus carrying out the reconnection process simultaneously, and to carry out a stable transmission and reception of content information.

However, with such a heretofore known information distribution system, in the case that a long time is taken for the connection process, due to a performance of the terminal apparatus carrying out the reconnection process, or a kind or condition of a communication line, during that time, as well as the terminal apparatus carrying out the reconnection process, all the other terminal apparatus connected to the downstream of the terminal apparatus also fall into a condition of being unable to acquire content information, meaning that there has been a danger of impeding the stable transmission and reception of content information.

Therein, the invention having been contrived in order to solve the heretofore described problem, it is desirable to provide a terminal apparatus and recording medium on which a program is recorded, as well as a reconnection process method, in an information distribution system which enables a stable transmission and reception of content information by more swiftly completing a reconnection process in the information distribution system.

According to an embodiment of the invention, there is provided a terminal apparatus in an information distribution system in which a plurality of terminal apparatus are connected in multilayers on a network in a hierarchical structure, with an information distribution apparatus as an apex, and information distributed from the information distribution apparatus is sequentially relayed downstream in the hierarchical structure by a relay function of each of the terminal apparatus, enabling an acquisition of the information by the plurality of terminal apparatus. The terminal apparatus includes a connection condition detection module which detects that it has become necessary to reconnect to another terminal apparatus different from an apparatus connected upstream in the hierarchical structure, a connection process module which, on detecting that the reconnection has become necessary, starts a process of connecting to another terminal apparatus configuring the hierarchical structure, a connection request module which, on detecting that the reconnection has become necessary, requests of an apparatus connected downstream in the hierarchical structure a process of connecting to another terminal apparatus configuring the hierarchical structure, and a reception control module which, on the connection process of the apparatus connected downstream finishing before the connection process using the connection process module finishes, receives the information with the apparatus connected downstream as an upstream apparatus.

### BRIEF DESCRIPTION OF THE DRAWINGS

FIGS. 1A and 1B are diagrams showing an outline configuration of an information distribution system in a first embodiment;

FIG. 2 is an illustration of a process of reconnecting to a tree-shaped hierarchical structure in the first embodiment;

FIG. 3 is an illustration of the process of reconnecting to the tree-shaped hierarchical structure in the first embodiment;

FIG. 4 is an illustration of the process of reconnecting to the tree-shaped hierarchical structure in the first embodiment;

FIG. 5A is an illustration of the process of reconnecting to the tree-shaped hierarchical structure in the first embodiment;

FIG. 5B is an illustration of the process of reconnecting to the tree-shaped hierarchical structure in the first embodiment;

FIG. 6A is an illustration of the process of reconnecting to the tree-shaped hierarchical structure in the first embodiment;

FIG. 6B is an illustration of the process of reconnecting to the tree-shaped hierarchical structure in the first embodiment;

FIG. 7 is an illustration of the process of reconnecting to the tree-shaped hierarchical structure in the first embodiment;

FIG. 8 is a diagram showing an outline configuration of a terminal apparatus in the first embodiment;

FIG. 9 is a flowchart showing one example of operational details-of the terminal apparatus in the first embodiment;

FIG. 10 is a flowchart showing one example of the operational details of the terminal apparatus in the first embodiment;

FIG. 11 is a flowchart showing one example of the operational details of the terminal apparatus in the first embodiment;

FIG. 12 is a flowchart showing one example of the operational details of the terminal apparatus in the first embodiment;

FIG. 13 is an illustration of a process of reconnecting to a tree-shaped hierarchical structure in a second embodiment;

FIG. 14 is an illustration of the process of reconnecting to the tree-shaped hierarchical structure in the second embodiment;

FIG. 15 is a flowchart showing one example of operational details of a terminal apparatus in the second embodiment; and

FIG. 16 is a flowchart showing one example of the operational details of the terminal apparatus in the second embodiment.

### DESCRIPTION OF THE PREFERRED EMBODIMENT(S)

### First Embodiment

1.1 Configuration and the like of Information Distribution System

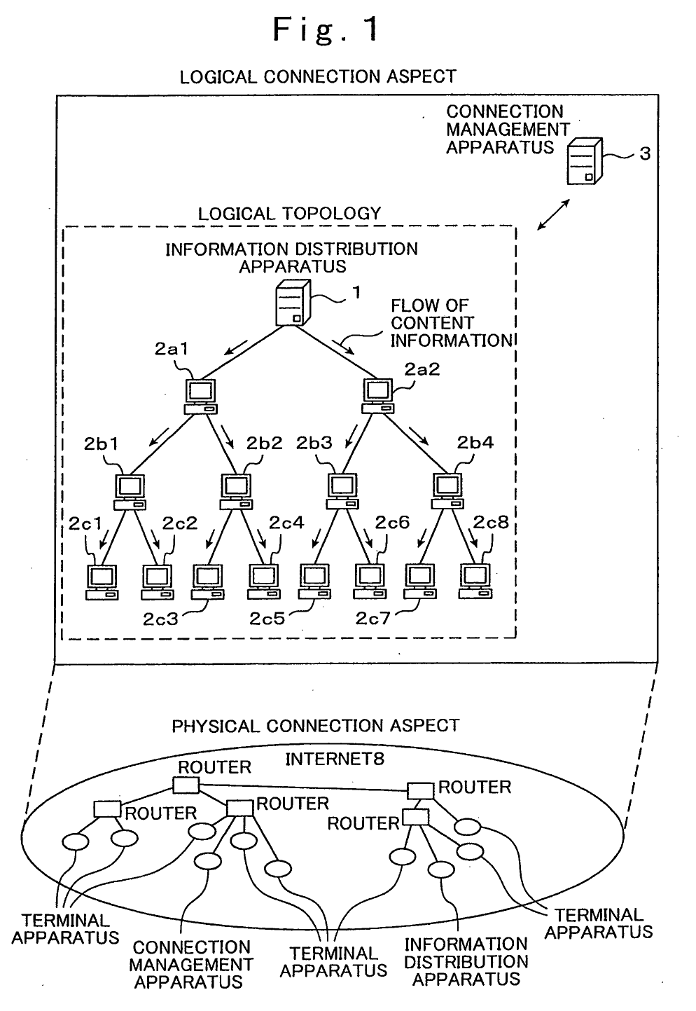

Firstly, referring to FIGS. 1A and 1B, a description will be given of an outline configuration of an information distribution system S. FIGS. 1A and 1B are diagrams showing an example of the outline configuration of the information distribution system S according to an embodiment.

As shown in FIG. 1 (Logical Connection Aspect), the information distribution system S according to the embodiment includes an information distribution apparatus 1, which distributes content information such as music data, image data or document data via a network, a plurality of terminal apparatus 2a1, 2a2, 2b1 to 2b4, and 2c1 to 2c8, logically connected in multilayers on the network in a tree-shaped hierarchical structure (hereafter called a “tree-shaped hierarchical structure”), with the information distribution apparatus 1 as an apex, and a connection management apparatus 3, which manages the tree-shaped hierarchical structure. Although a quantity of the terminal apparatus is taken here to be fourteen, this is not limited to fourteen.

IP addresses being allotted to each of the information distribution apparatus 1, the terminal apparatus 2a1, 2a2, 2b1 to 2b4, and 2c1 to 2c8, and the connection management apparatus 3, these apparatus are connected via a router or the like to an internet 8, as one example of the network, as shown in FIG. 1 (Physical Connection Aspect). A communicative connection between the apparatus is enabled by transmitting a packet including a header with a target connection destination apparatus IP address as a destination IP address, and an own apparatus IP address as a transmission source IP address. Then, the information distribution apparatus 1 and the terminal apparatus 2a1, 2a2, 2b1 to 2b4, and 2c1 to 2c8 being logically connected by a session being established between the apparatus, the tree-shaped hierarchical structure is constructed as shown in FIG. 1 (Logical Connection Aspect). Also, although the information distribution apparatus 1 and connection management apparatus 3 are described separately here, it is also acceptable that the connection management apparatus 3 is included inside the information distribution apparatus 1. In this case, it is possible to share the IP address of the information distribution apparatus 1, without allotting an IP address to the connection management apparatus 3. When indicating any one of terminal apparatus of the terminal apparatus 2a1, 2a2, 2b1 to 2b4, and 2c1 to 2c8, or all of the terminal apparatus, they may be called the terminal apparatus 2, for the sake of convenience.

The information distribution system S is managed by the connection management apparatus 3 in such a way that the plurality of terminal apparatus 2 are logically connected in multilayers in the tree-shaped hierarchical structure, with the information distribution apparatus 1 as the apex. The information distribution apparatus 1 transmits content information to the terminal apparatus 2a1 and 2a2. The terminal apparatus 2a1 and 2a2, on receiving the content information from the information distribution apparatus 1 connected upstream, relay the received content information to the terminal apparatus 2b1 to 2b4 connected downstream (hereafter also called “downstream apparatus”). In the same way, the terminal apparatus 2b1 to 2b4, on receiving the content information, relay the received content information to the terminal apparatus 2c1 to 2c8 connected downstream.

In this way, in the information distribution system S, the content information distributed from the information distribution apparatus 1 being sequentially relayed to the downstream terminal apparatus 2 by a relay function of the terminal apparatus 2, the content information is distributed to all the terminal apparatus 2 participating in the information distribution system S, and configuring the tree-shaped hierarchical structure. Apart from content data such as music and a movie, information on a reproduction time (hereafter called “reproduction time data”) is included in the distributed content information. Then, the plurality of terminal apparatus 2 which receive the content information carry out a reproduction of the sequentially transmitted content information, based on the reproduction time data. Thus, in the information distribution system S, the content information transmitted from the information distribution apparatus 1 being distributed to the plurality of terminal apparatus 2, it is possible to reproduce the content information in the plurality of terminal apparatus 2 at the same time. That is, a broadcast format streaming distribution to the plurality of terminal apparatus 2 is realized using a P2P.

1.2 Method of the Process of Reconnecting to Tree-Shaped Hierarchical Structure

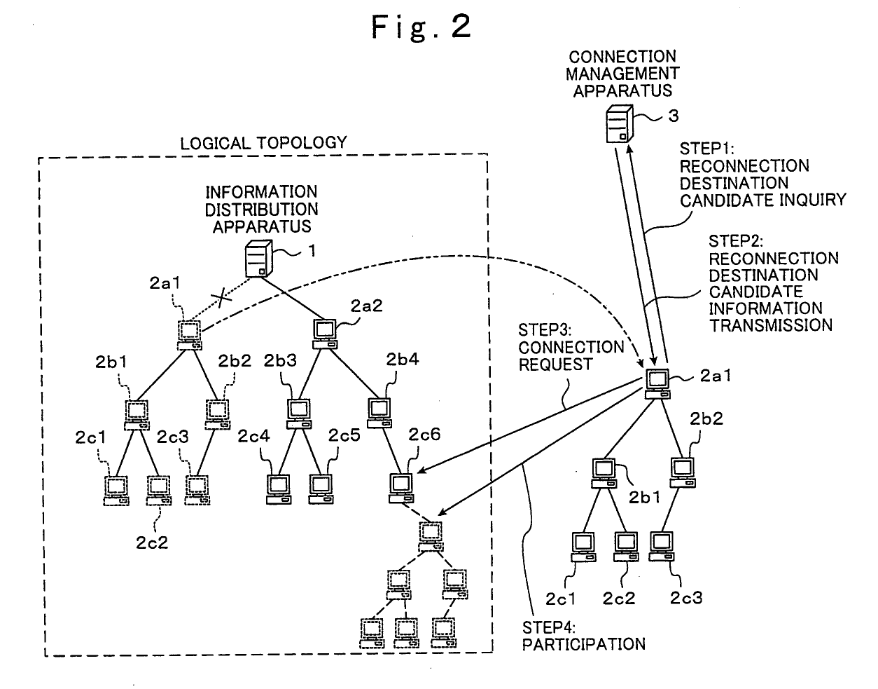

Next, a specific description will be given, referring to the drawings, of an operation of reconnecting to the tree-shaped hierarchical structure in the information distribution system S. FIGS. 2 to 7 are diagrams for illustrating the operation of reconnecting to the tree-shaped hierarchical structure in the information distribution system S. The following operation is realized by information processing by a controller of the terminal apparatus 2 and a controller of the connection management apparatus 3.

In the case that, for example, the connection between the information distribution apparatus 1 and the terminal apparatus 2a1 is disconnected due to a deterioration of a communication condition, or the like, as shown in FIG. 2, the terminal apparatus 2a1, using a connection condition detection module, detects that it has become necessary to reconnect to another terminal apparatus differing from the apparatus connected upstream in the hierarchical structure. Then, on detecting, using the connection condition detection module, that it has become necessary to reconnect, the terminal apparatus 2a1, as well as starting a process of connecting to another terminal apparatus 2 configuring the hierarchical structure, as a first connection process, using a connection process module, requests a process of connecting to another terminal apparatus 2 configuring the hierarchical structure of the terminal apparatus 2 connected downstream, using a connection request module. In the embodiment, cases in which “it has become necessary to reconnect” include, besides a case in which a connection with an apparatus connected to the upstream (hereafter called an “upstream apparatus”) of an own terminal apparatus 2 has been disconnected, as heretofore described, a case in which a communication condition has become worse than a predetermined condition, a case of receiving a withdrawal message transmitted to a downstream apparatus from an upstream apparatus when withdrawing from the information distribution system S, and the like.

Firstly, a specific description will be given of the connection process.

The terminal apparatus 2a1, on starting the connection process, firstly, makes an inquiry to the connection management apparatus 3 about a connection destination candidate (refer to Step 1 shown in FIG. 2). The inquiry is made by the terminal apparatus 2a1 transmitting a connection destination inquiry message, including own terminal apparatus location information, to the connection management apparatus 3. At this time, a sub-tree having the terminal apparatus 2a1 as an apex is in a maintained condition (that is, a condition in which the terminal apparatus 2b1 and 2b2 are connected to the downstream of the terminal apparatus 2a1, and furthermore, the terminal apparatus 2c1 and 2c2 are connected to the downstream of the terminal apparatus 2b1, and the terminal apparatus 2c3 is connected to the downstream of the terminal apparatus 2b2).

The connection management apparatus 3 stores connection condition information on the plurality of terminal apparatus 2 configuring the tree-shaped hierarchical structure (for example, a connection position of each terminal apparatus 2 in the tree-shaped hierarchical structure, location information of each terminal apparatus 2, and the like) and, on receiving the connection destination inquiry message from the terminal apparatus 2a1, selects a connection destination candidate based on the stored connection condition information.

Subsequently, the connection management apparatus 3 sends information on the selected connection destination candidate (location information, and a connection position in the tree-shaped hierarchical structure, of the connection destination candidate) to the terminal apparatus 2a1, which has transmitted the connection destination inquiry message (refer to Step 2 shown in FIG. 2).

The terminal apparatus 2a1, on receiving the connection destination candidate from the connection management apparatus 3, makes a request for a connection to the selected terminal apparatus 2 (taken here to be the terminal apparatus 2c6), which has become the connection destination candidate (refer to Step 3 shown in FIG. 2), and participates in the tree-shaped hierarchical structure, with the relevant terminal apparatus 2 as an upstream apparatus (refer to Step 4 shown in FIG. 2).

Next, a specific description will be given of the connection request module.

The terminal apparatus 2a1, by requesting the process of connecting to another terminal apparatus 2 configuring the hierarchical structure of the terminal apparatus 2 connected downstream, using the connection request module, carries out a process of connecting not only its own terminal apparatus 2, but also the terminal apparatus 2 connected downstream thereof.

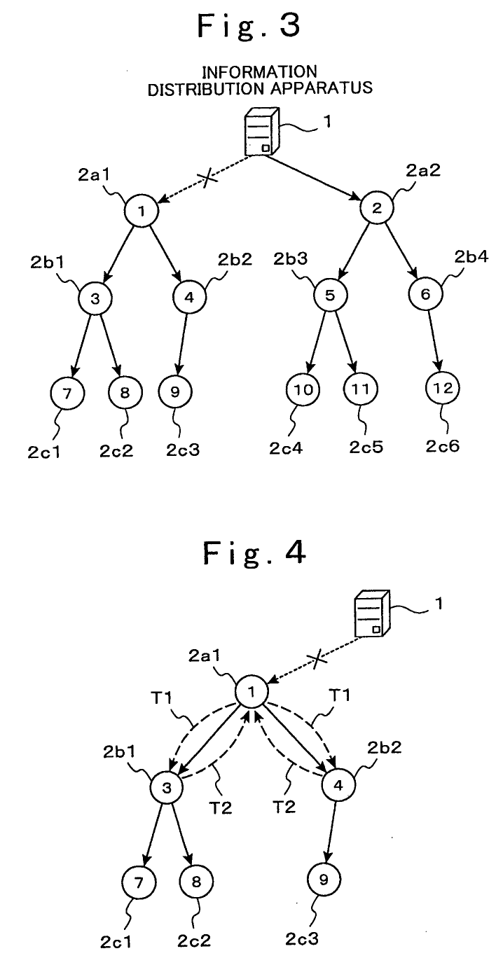

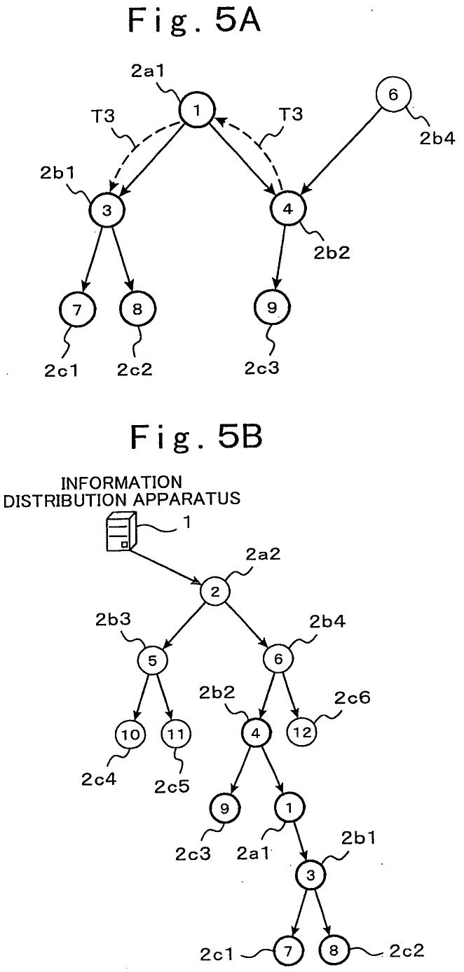

That is, in the case that the connection between the information distribution apparatus 1 and the terminal apparatus 2a1 is disconnected, as shown in FIG. 3, the terminal apparatus 2a1, as well as detecting that the connection has been disconnected, using the connection condition detection module, and beginning the connection process, as heretofore described, transmits a connection request message T1 to, among the downstream apparatus 2b1, 2b2, 2c1, 2c2 and 2c3, the downstream apparatus 2b1 and 2b2, which are directly connected to the terminal apparatus 2a1 itself, as shown in FIG. 4. Then, the terminal apparatus 2b1 and 2b2, which have received the connection request message T1, after transmitting a request acceptance message T2 to the terminal apparatus 2a1, start a requested connection process, in response to the request, as a second connection process. The requested connection process is the same kind of process as the heretofore described connection request. In the figure, a number described in each circle representing the terminal apparatus 2 is to facilitate a description of a relationship of connection positions of each terminal apparatus 2.

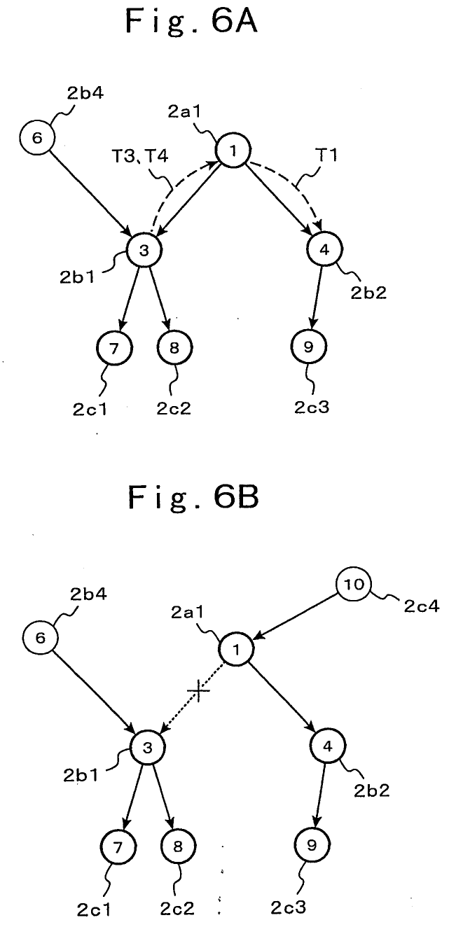

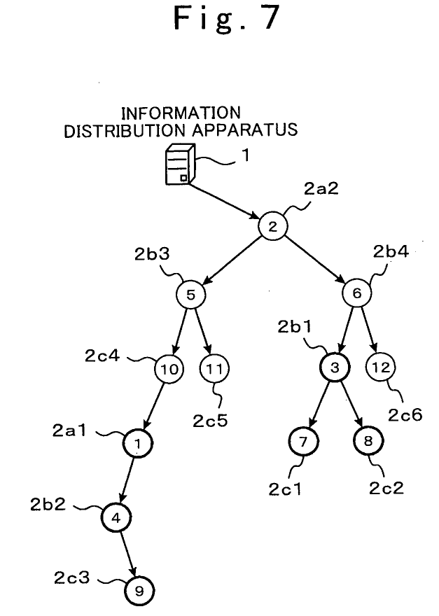

Herein, in the case that the terminal apparatus 2b2, connected to the downstream of the terminal apparatus 2a1, finishes the connection process before the terminal apparatus 2a1 finishes the connection process (herein, in a case in which the terminal apparatus 2b2 is connected to the terminal apparatus 2b4), the terminal apparatus 2b2 transmits a connection completion notification T3 to the terminal apparatus 2a1, as shown in FIG. 5A. Then, the terminal apparatus 2a1, which has received the connection completion notification T3, receives content information, using a reception control module, with the terminal apparatus 2b2 as an upstream apparatus. That is, the terminal apparatus 2a1, which has originally been the upstream apparatus of the terminal apparatus 2b2, on receiving the connection completion notification from the terminal apparatus 2b2, configures a sub-tree having the terminal apparatus 2b2 as an apex, as shown in FIG. 5B, by making a request to the terminal apparatus 2b2 for a transmission of content information.

In this way, in the information distribution system S according to the embodiment, the terminal apparatus 2, on detecting that it has become necessary to reconnect to another terminal apparatus 2 differing from the terminal apparatus 2 connected upstream, as well as starting the process of connecting to the other terminal apparatus 2 configuring the tree-shaped hierarchical structure, requests a connection process of the apparatus connected downstream in the hierarchical structure and, in the case that the connection process of the apparatus connected downstream finishes before the connection process of the terminal apparatus 2 itself finishes, receives content information with the apparatus connected downstream as an upstream apparatus, meaning that it is possible to complete the reconnection process more swiftly, enabling a stable transmission and reception of content information.

In the case that there is a terminal apparatus 2 which has accepted the connection request message (herein, the terminal apparatus 2b1), other than the terminal apparatus 2 which has completed the connection (herein, the terminal apparatus 2b2), the terminal apparatus 2a1 transmits the connection completion notification T3 to the terminal apparatus 2b1, as shown in FIG. 5A, which means it is possible to prevent a situation wherein the connection process continues to be executed even after one of the terminal apparatus 2 has finished the connection process, and it has become unnecessary to carry out the process.

Also, in the information distribution systems according to the embodiment, the terminal apparatus 2 makes a request for the connection process when an average value of time for the connection process with the connection process module, taken in the past by a terminal apparatus for which the reconnection has become necessary, is equal to or greater than a predetermined value.

That is, the terminal apparatus 2 stores time needed from a start to a finish of connection processes carried out in the past, and on detecting, using the connection condition detection module, that a reconnection is necessary, firstly, calculates an average value of the stored time and, only when the average value is equal to or greater than a predetermined value, transmits a connection request message to the apparatus connected downstream in the hierarchical structure.

By adopting such a configuration, for example, in a case in which, due to an apparatus performance, a kind of communication line, or the like, it is possible to finish the connection process in an extremely short time, that is, in a case in which there is no need to carry out the connection process together with the terminal apparatus 2 connected downstream, no request for the connection process is made, meaning that it is possible to prevent any superfluous burden being placed on the network.

It is also acceptable that the calculation of the average value is carried out not when it is detected, using the connection condition detection module, that a reconnection is necessary, but before detecting that a reconnection is necessary (for example, after completing the connection process, or the like). By adopting such a configuration, it is possible to make a request for a connection process more swiftly.

Also, in the information distribution system S according to the embodiment, the reception control module of the terminal apparatus 2, on the connection process using the connection process module finishing after the connection process of the apparatus connected downstream finishes, switches the apparatus which receives the information from the apparatus connected downstream to the apparatus connected using the connection process module.

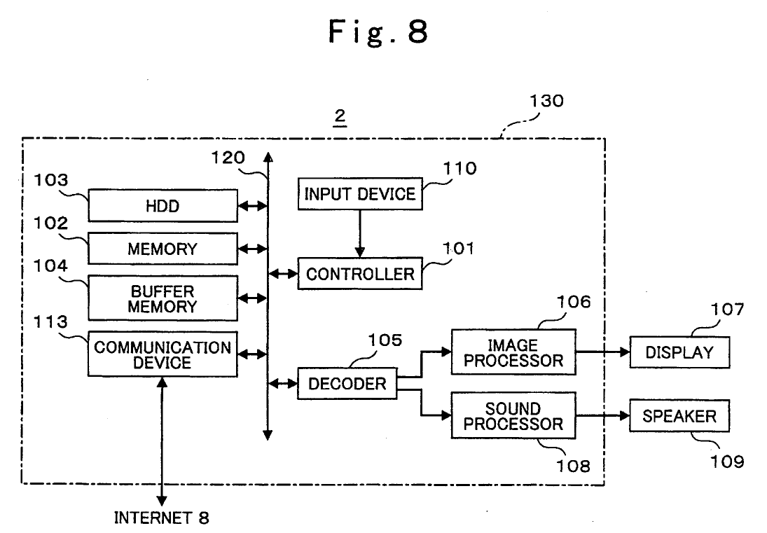

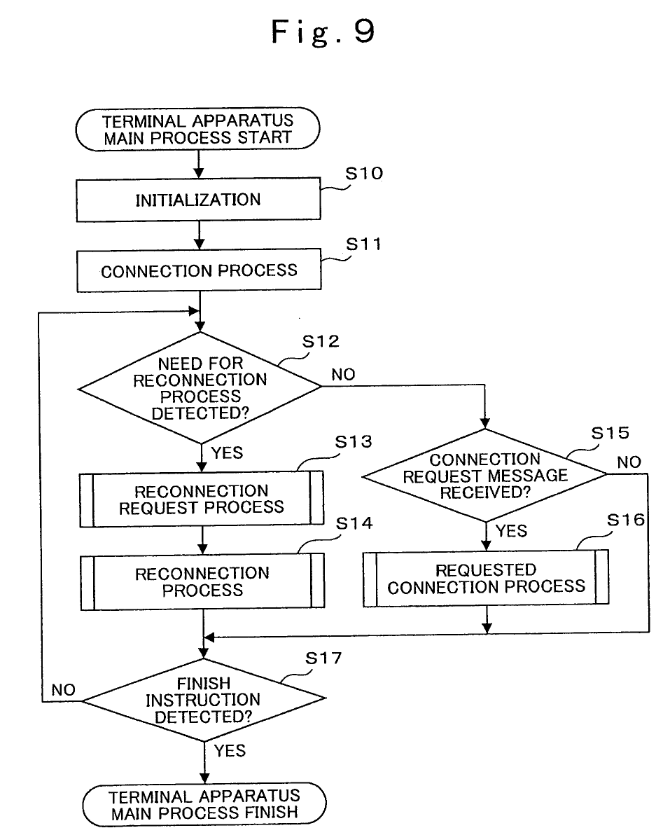

That is, in a case in which, in the condition shown in FIG. 4, the terminal apparatus 2b1 completes the connection process before the terminal apparatus 2a1, and is connected to the downstream of the terminal apparatus 2b4, as shown in FIG. 6A, further in the case that a quantity of downstream apparatus directly connected to the terminal apparatus 2b1 exceeds two, which is a prescribed quantity of connectable downstream apparatus in the information distribution system S (hereafter, also called an “upper limit connection quantity”), the terminal apparatus 2b1 transmits a notification T4, to the effect that the upper limit connection quantity has been exceeded, to the terminal apparatus 2a1, together with the connection completion notification T3.

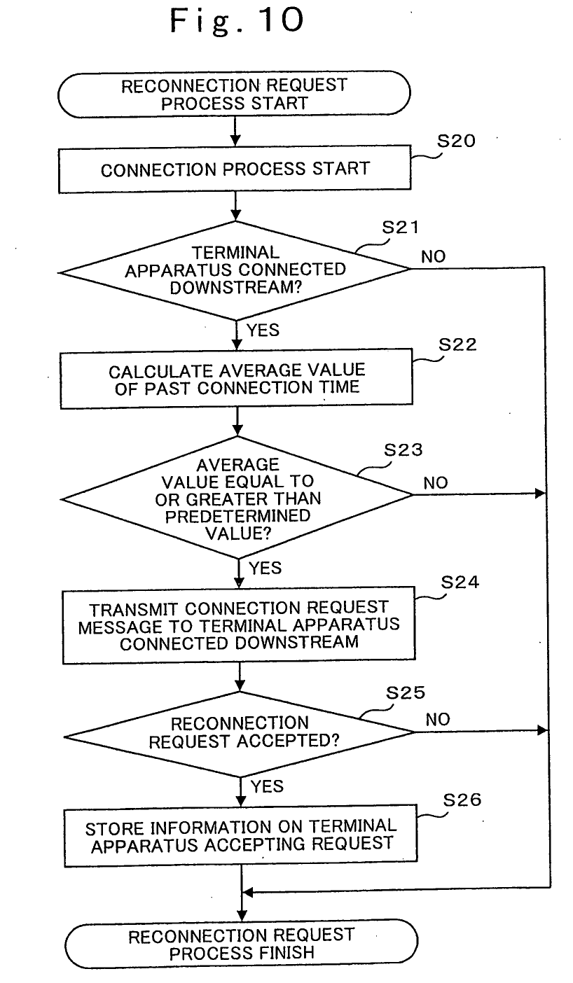

Then, the terminal apparatus 2a1, which has received the connection completion notification T3, and the notification T4 to the effect that the upper limit connection quantity has been exceeded, with respect to the terminal apparatus 2b1, temporarily receives content information with the terminal apparatus 2b1 as an upstream apparatus, but continues the connection process at that time too. Then, in a case in which it completes the connection process, and is connected to the downstream of the terminal apparatus 2c4, as shown in FIG. 6B, the terminal apparatus 2a1 disconnects the connection with the terminal apparatus 2b1, and receives content information from the terminal apparatus 2c4 connected using the connection process module. Thus, the terminal apparatus 2a1, 2b2 and 2c3, and the terminal apparatus 2b1, 2c1 and 2c2, configure sub-trees each of which has a different terminal apparatus 2 as an apex. Specifically, as shown in FIG. 7, the terminal apparatus 2a1, 2b2 and 2c3 configure a sub-tree having the terminal apparatus 2c4 as an apex, while the terminal apparatus 2b1, 2c1 and 2c2 configure a sub-tree having the terminal apparatus 2b1 as an apex.

By adopting such a configuration, in the case that the connection process of the apparatus connected downstream finishes before the connection process of the terminal apparatus 2 which has made the connection process request finishes, by the downstream apparatus transmitting content information to the terminal apparatus 2 which has made the connection process request, despite the upper limit connection quantity being exceeded, it is possible to prevent a localized increase in the burden on the network.

In the same way as illustrated in FIG. 6A, the terminal apparatus 2a1 transmits the connection completion notification T3 to a terminal apparatus 2 which has accepted the connection request message (herein, the terminal apparatus 2b2), other than the terminal apparatus 2 which has completed the connection (herein, the terminal apparatus 2b1).

Also, in the information distribution system S according to the embodiment, the connection request module of the terminal apparatus 2, in the case that the connection process using the connection process module finishes before the connection process of the apparatus connected downstream finishes, requests the apparatus connected downstream in the hierarchical structure to stop the connection process. By adopting such a configuration, in the same way as heretofore described, it is possible to prevent the situation wherein the connection process continues to be executed even after one of the terminal apparatus 2 has finished the connection process, and it has become unnecessary to carry out the process.

1.3. Specific Configuration and Operations of Terminal Apparatus

Next, referring to the drawings, a description will be given of a configuration and operations of the terminal apparatus 2.

Configuration of Terminal Apparatus

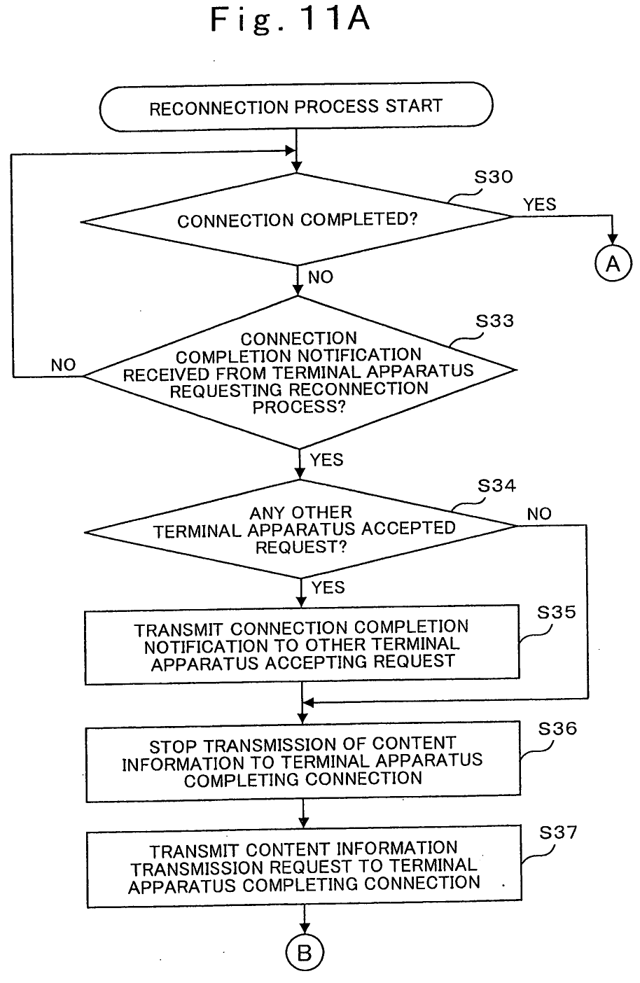

Firstly, a description will be given of the configuration of the terminal apparatus 2. FIG. 8 is a diagram showing an outline configuration of the terminal apparatus 2 in the information distribution system S according to the embodiment.

To the terminal apparatus 2, a general personal computer, as well as a dedicated computer is applicable, and the terminal apparatus 2 includes a controller 101, a rewritable memory 102, which stores time needed from a start to a finish of connection processes carried out by its own terminal apparatus 2 in the past, other various kinds of parameters, and the like, a hard disc (HDD) 103, which stores content information acquired from the information distribution apparatus 1 and other terminal apparatus 2, a buffer memory 104, which temporarily stores the content information acquired from the information distribution apparatus 1 and the other terminal apparatus 2, a decoder 105, which sequentially retrieves and decodes the content information stored on the hard disc 103 and in the buffer memory 104, an image processor 106, which converts image information, among the content information decoded by the decoder 105, into information which can be displayed on a display 107, to be described hereafter, the display 107, such as a liquid crystal display device (LCD), which displays an image of content information based on an output from the image processor 106, a sound processor 108, which converts sound information, among the content information decoded by the decoder 105, into information which can be output as a sound wave from a speaker 109, to be described hereafter, the speaker 109, which outputs the sound wave based on an output from the sound processor 108, an input device 110 including a mouse, a keyboard or the like, and a communication device 113, for communicating with the information distribution apparatus 1, the other terminal apparatus 2, and the connection management apparatus 3, via the internet 8, as shown in FIG. 8. The controller 101, the memory 102, the hard disc 103, the buffer memory 104, the decoder 105, and the communication device 113 are mutually connected via a system bus 120.

The controller 101 is configured of a CPU (Central Processing Unit), an internal ROM (Read Only Memory), and an internal RAM (Random Access Memory). An information processing program, for participating in the tree-shaped hierarchical structure of the information distribution system S and acquiring content information, being stored in the internal ROM, the CPU, by retrieving and executing the information processing program stored in the internal ROM, functions as the connection condition detection module, the connection process module, the connection request module, and the like, to be described hereafter.

It is acceptable that the information processing program is, for example, downloaded from a server (for example, the connection management apparatus 3) connected to the internet 8, via the communication device 113, into the internal ROM of the controller 101, and it is also acceptable that, after being recorded on a recording medium such as a CD-ROM, it is loaded into the internal ROM of the controller 101 via an unshown recording medium drive. In this case, it is desirable that the internal ROM is configured of a flash memory or the like.

Operations of Terminal Apparatus

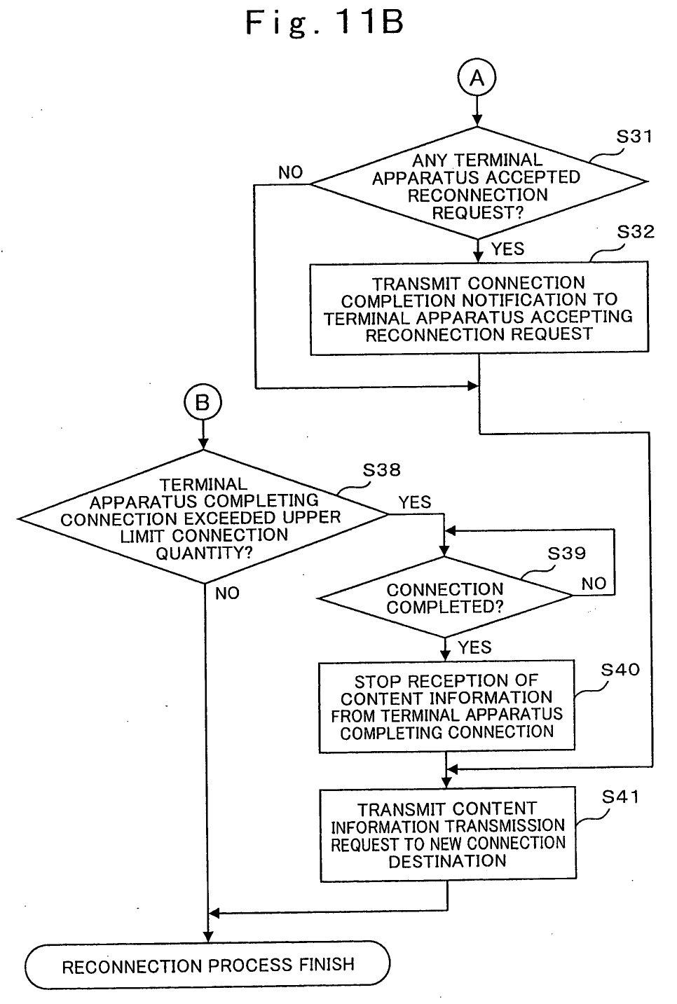

A specific description will be given of operations of the terminal apparatus 2 configured as heretofore described. FIGS. 9 to 12 are flowcharts showing one example of terminal apparatus 2 operational details. Each of the following processes is executed by the controller 101 of the terminal apparatus 2 functioning as each heretofore described module, and the like.

As shown in FIG. 9, when a main power switch (not shown) is activated, or a reset switch (not shown) is operated, in the terminal apparatus 2, the CPU of the controller 101, after executing initial setting operations, such as permission to access the memory 102 and securing an operational area of the internal RAM, retrieving the information processing program stored in the internal ROM, and putting the functions as the controller 101 into an operational condition (step S10), shifts the process to step S11.

In step S11, the controller 101 carries out the connection process. Specifically, on starting the connection process, the controller 101 makes a participation request to the connection management apparatus 3. That is, the controller 101 transmits a connection destination inquiry message, including its own apparatus location information and the like, to the connection management apparatus 3, via the communication device 113. Subsequently, the controller 101 acquires location information (the IP address or the like) of a connection destination candidate (the information distribution apparatus 1 or a terminal apparatus 2) from the connection management apparatus 3, via the communication device 113. Next, the controller 101 makes a connection request to the connection destination candidate replied by the connection management apparatus 3, and participates in the tree-shaped hierarchical structure with the connection destination candidate as an upstream apparatus. Subsequently, the controller 101 transmits a participation report to the connection management apparatus 3, via the communication device 113, and finishes the connection process.

Next, the controller 101 determines whether or not it has been detected that the reconnection process is necessary (step S12). Herein, this determination is made based on whether or not a condition of a communication with the upstream apparatus has become a non-connected condition, or a condition worse than the predetermined value, or alternatively, on whether or not a withdrawal message, transmitted from the upstream apparatus when the upstream apparatus withdraws from the information distribution system S, has been received. In this way, the controller 101 functions as the connection condition detection module which detects that there is a need for a reconnection to another terminal apparatus 2 different from the apparatus connected upstream in the hierarchical structure.

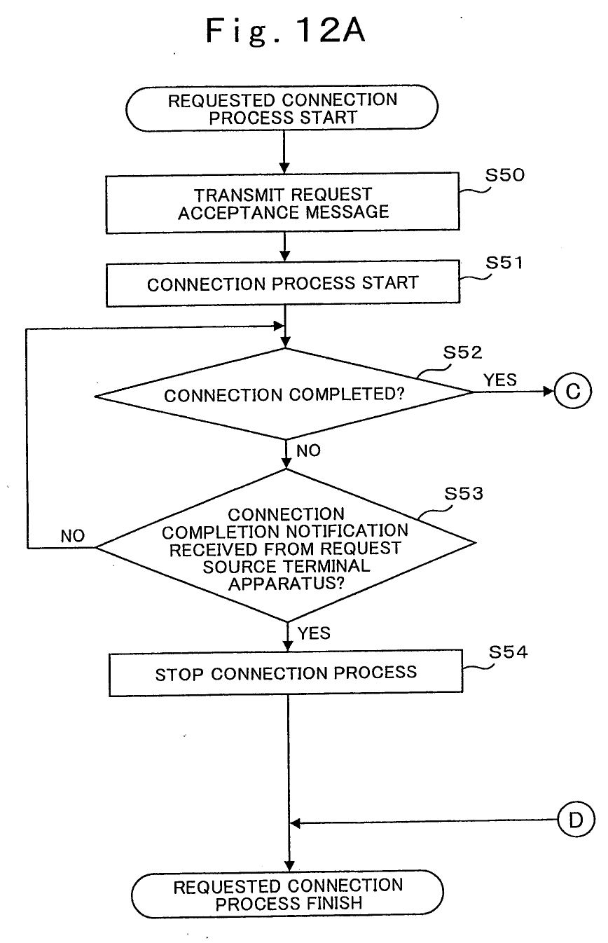

If it is determined, in this process, that it has been detected that the reconnection process is necessary (step S12: Yes), the controller 101 carries out a reconnection request process of step S13. The reconnection request process, being the process of steps S20 to S26 in FIG. 10, will be described hereafter.

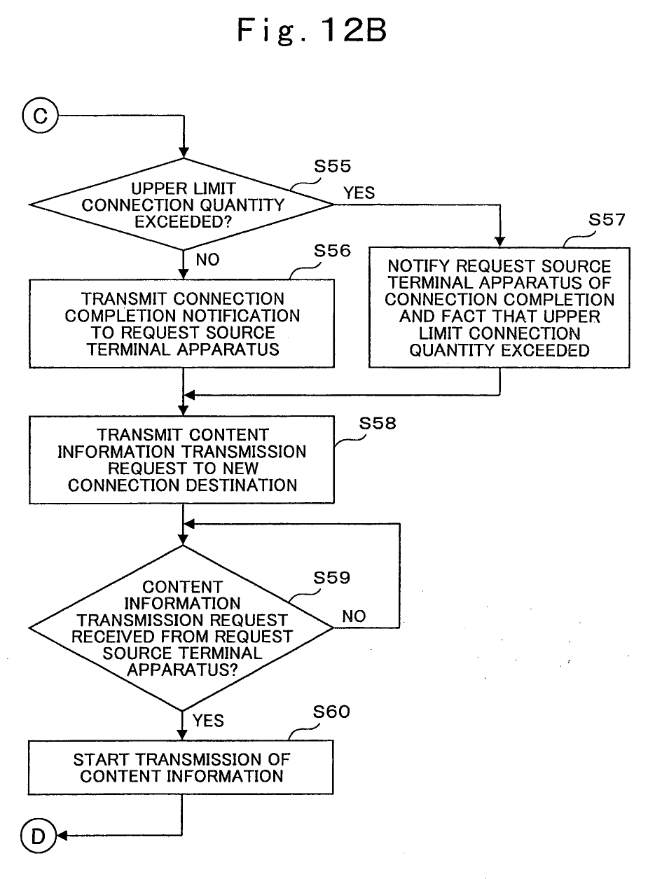

On finishing the reconnection request process of step S13, the controller 101 carries out the reconnection process (step S14). The reconnection process, being the process of steps S30 to S41 in FIG. 11, will be described hereafter.

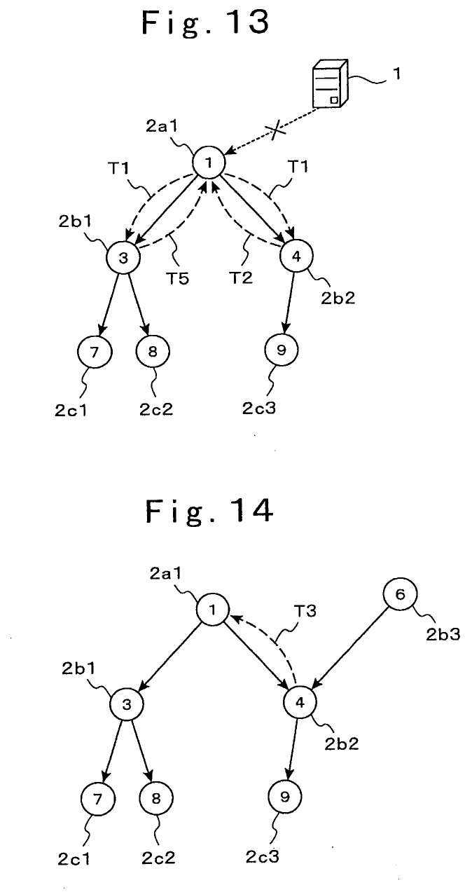

Meanwhile, when it is not detected, in step S12, that the reconnection process is necessary (step S12: No), the controller 101 determines whether or not it has received a connection request message from an upstream apparatus (step S15). If it is determined, in this process, that a connection request message has been received from an upstream apparatus (step S15: Yes), the controller 101 carries out the requested connection process (step S16). The requested connection process, being the process of steps S50 to S60 in FIG. 12, will be described hereafter.

When the processes of steps S14 and S16 are finished, or when no connection request message is received from an upstream apparatus in step S15 (step S15: No), the controller 101 determines whether or not a finish instruction has been detected (step S17). For example, when a power supply of its own terminal apparatus 2 has shifted to a deactivated condition, the controller 101 detects a finish instruction.

If it is determined, in step S17, that a finish instruction has been detected (step S17: Yes), the controller 101 finishes the main process, while if it is determined that no finish instruction has been detected (step S17: No), the controller 101 repeats the process from step S12.

Next, a specific description will be given, referring to the flowchart of FIG. 10, of the reconnection request process in step S13. FIG. 10 is a flowchart of the reconnection request process in the terminal apparatus 2.

As shown in FIG. 10, on starting the reconnection request process, the controller 101, firstly, starts the connection process (step S20). The connection process is the same kind of process as step S11 in FIG. 9. The connection process is carried out until it is determined, in step S30 in FIG. 11, to be described hereafter, that the connection process is completed (step S30: Yes), or until it is determined, in step S39, that the connection process is completed (step S39: Yes). In this way, the controller 101, on detecting that a reconnection is necessary, functions as the connection process module, which starts the process of connecting to another terminal apparatus 2 configuring the hierarchical structure.

Next, the controller 101 determines whether or not a terminal apparatus 2 is connected to the downstream of its own terminal apparatus 2 (whether or not a downstream apparatus exists) (step S21). If it is determined, in this process, that a terminal apparatus 2 is connected to the downstream of its own terminal apparatus 2 (step S21: Yes), the controller 101 shifts the process to step S22.

In step S22, the controller 101 carries out a calculation of an average time needed from a connection start to a connection finish of connection processes carried out in the past. Then, the controller 101 determines whether or not the average value calculated in step S22 is equal to or greater than the predetermined value (step S23). If it is determined, in this process, that the calculated average value is equal to or greater than the predetermined value (step S23: Yes), the controller 101 shifts the process to step S24.

In step S24, the controller 101 transmits a connection request message, via the network, to a downstream apparatus connected directly to its own terminal apparatus 2, requesting a process of connecting to another terminal apparatus 2 configuring the hierarchical structure. In this way, the controller 101, on detecting that a reconnection is necessary, functions as the connection request module, which makes a request to an apparatus connected downstream in the hierarchical structure for a process of connecting to another terminal apparatus 2 configuring the hierarchical structure.

Next, the controller 101 determines whether or not the connection request message transmitted to the downstream apparatus connected directly to its own terminal apparatus 2 has been accepted within the predetermined time (step S25). This determination is made based on whether or not a request acceptance message has been received from the downstream apparatus within a predetermined time. If it is determined, in this process, that the connection request message has been accepted within the predetermined time (step S25: Yes), the controller 101 stores information (the IP address or the like) on the terminal apparatus 2 which has accepted the request (step S26)

When the process of step S26 is finished, or alternatively when there is no terminal apparatus 2 connected to the downstream of its own terminal apparatus 2 in step S21 (step S21: No), when the calculated average value is not equal to or greater than the predetermined value in step S23 (step S23: No), or when the connection request message is not accepted in step S25 (step S25: No), the controller 101 finishes the reconnection request process.

Next, a specific description will be given, referring to the flowchart of FIG. 11, of the reconnection process in step S14. FIG. 11 is a flowchart of the reconnection process in the terminal apparatus 2.

As shown in FIG. 11, on starting the reconnection process, the controller 101 determines whether or not the connection process is completed (step S30). If it is determined, in this process, that the connection process is completed (step S30: Yes), the controller 101 shifts the process to step S31.

In step S31, the controller 101 determines whether or not there exists a terminal apparatus 2 which has accepted the reconnection request. This determination is made based on whether or not a request acceptance message has been received from the downstream apparatus to which the connection request message has been transmitted. If it is determined, in this process, that there exists a terminal apparatus 2 which has accepted the reconnection request (step S31: Yes), the controller 101 transmits a connection completion notification to the terminal apparatus 2 which has accepted the reconnection request (step S32).

When the process of step S32 is finished, or alternatively when no terminal apparatus 2 which has accepted the reconnection request exists in step S31 (step S31: No), the controller 101 shifts the process to step S41.

Meanwhile when, in step S30, the connection process is not completed (step S30: No), the controller 101 determines whether or not a connection completion notification has been received from the downstream apparatus of which it has requested the reconnection process (step S33). If it is determined, in this process, that a connection completion notification has been received from the downstream apparatus of which it has requested the reconnection process (step S33: Yes), the controller 101 shifts the process to step S34, while when no connection completion notification has been received (step S33: No), the controller 101 shifts the process to step S30.

In step S34, the controller 101 determines whether or not there exists a terminal apparatus 2 which has accepted the reconnection request, other than the terminal apparatus 2 which has transmitted the connection completion notification. This determination is made based on the information (the IP address or the like), stored in step S26 of FIG. 10, on the terminal apparatus 2 which has accepted the request. If it is determined, in this process, that there exists a terminal apparatus 2 which has accepted the reconnection request, other than the terminal apparatus 2 which has transmitted the connection completion notification (step S34: Yes), the controller 101 transmits a connection completion notification to that terminal apparatus 2 (step S35).

When finishing the process of step S35, or alternatively when there exists no terminal apparatus 2 which has accepted the reconnection request, other than the terminal apparatus 2 which has transmitted the connection completion notification (step S34: No), the controller 101 stops the transmission of content information to the downstream apparatus which has completed the connection (step S36), and transmits a content information transmission request to the downstream apparatus which has completed the connection (step S37).

Next, the controller 101 determines whether or not a quantity of the downstream apparatus connected to the terminal apparatus 2 which has completed the connection exceeds a predetermined value (an upper limit connection quantity) (step S38). This determination is made based on whether or not a notification to the effect that the upper limit connection quantity has been exceeded has been received from the terminal apparatus 2 which has completed the connection. When it is determined, in this process, that the quantity of the downstream apparatus connected to the terminal apparatus 2 which has completed the connection exceeds the upper limit connection quantity (step S38: Yes), the controller 101 shifts the process to step S39.

In step S39, the controller 101 determines whether or not the connection process which its own terminal apparatus 2 is carrying out is completed. If it is determined, in this process, that the connection process is completed (step S39: Yes), the controller 101 stops the reception of content information from the downstream apparatus which has completed the connection (step S40), and transmits a content information transmission request to a terminal apparatus 2 which has newly become an upstream apparatus directly connected to its own terminal apparatus 2 (step S41).

When finishing the process of step S41, or alternatively when the quantity of the downstream apparatus connected to the terminal apparatus 2 which has completed the connection does not exceed the upper limit connection quantity (step S38: No), the controller 101 finishes the reconnection process.

Next, a specific description will be given, referring to the flowchart of FIG. 12, of the requested connection process in step S16. FIG. 12 is a flowchart of the requested connection process in the terminal apparatus 2.

As shown in FIG. 12, on starting the requested connection process, the controller 101 transmits a request acceptance message to the terminal apparatus 2 which has transmitted the connection request message (the upstream apparatus directly connected to its own terminal apparatus 2) (step S50), and starts the connection process (step S51). The connection process is the same kind of process as step S11 in FIG. 9. The connection process is carried out until it is determined, in step S52, that the connection process is completed (step S52: Yes), or alternatively until the connection process is stopped in step S54.

Next, the controller 101 determines whether or not the connection process is completed (step S52). When, in this process, the connection process is not completed (step S52: No), the controller 101 determines whether or not it has received a connection completion notification from a request source terminal apparatus 2 (step S53). Then, if it is determined, in this process, that a connection completion notification has been received from a request source terminal apparatus 2 (step S53: Yes), the controller 101 stops the connection process (step S54), while when no connection completion notification has been received from a request source terminal apparatus 2 (step S53: No), the controller 101 shifts the process to step S52.

Meanwhile, when it is determined, in step S52, that the connection process is completed (step S52: Yes), the controller 101 determines whether or not a quantity of the downstream apparatus directly connected to its own terminal apparatus 2 exceeds the upper limit connection quantity (step S55). When, in this process, the quantity of the downstream apparatus directly connected to its own terminal apparatus 2 does not exceed the upper limit connection quantity (step S55: No), the controller 101 transmits a connection completion notification to the request source terminal apparatus 2 (step S56). Meanwhile, if it is determined, in step S55, that the quantity of the downstream apparatus directly connected to its own terminal apparatus 2 exceeds the upper limit connection quantity (step S55: Yes), the controller 101 transmits a notification to the effect that the upper limit connection quantity has been exceeded, along with a connection completion notification, to the request source terminal apparatus 2 (step S57).

On finishing the processes of steps S56 and S57, the controller 101 transmits a content information transmission request to a terminal apparatus 2 which has newly become an upstream apparatus directly connected to its own terminal apparatus 2 (step S58). Then, the controller 101 determines whether or not it has received a content information transmission request from the request source terminal apparatus 2 (step S59) and, if it determines that it has received a content information transmission request from that terminal apparatus 2 (step S59: Yes), the controller 101 transmits content information to the terminal apparatus 2 (step S60).

When finishing the processes of steps S54 and S60, the controller 101 finishes the requested connection process.

### Second Embodiment

Next, a description will be given of operations of an information distribution system S′ in a second embodiment. In the information distribution system S in the heretofore described first embodiment, the terminal apparatus 2, on receiving a connection request message from an upstream apparatus, transmits a request acceptance message and starts the connection process, even in the case that the quantity of the downstream apparatus directly connected to the terminal apparatus 2 itself exceeds the upper limit connection quantity, but with the information distribution system S′ in the second embodiment, in the case that the quantity of the downstream apparatus directly connected to the terminal apparatus 2 itself exceeds the upper limit connection quantity when receiving a connection request message from an upstream apparatus, the terminal apparatus 2 refuses the reconnection request, and does not carry out the connection process. As operations other than the reconnection process and the requested connection process are the same kinds of process as those of the first embodiment, a description will be omitted here. Also, the same kind of configuration as that of the first embodiment will be described using reference numerals identical to those of the first embodiment. Also, in the terminal apparatus 2, in order to execute these kinds of operations, an information processing program is included in the internal ROM of the controller 101, in the same way as in the first embodiment.

Firstly, a description will be given, referring to FIGS. 3, 13 and 14, of a method of the process of reconnecting to the tree-shaped hierarchical structure in the information distribution system S′ of the second embodiment.

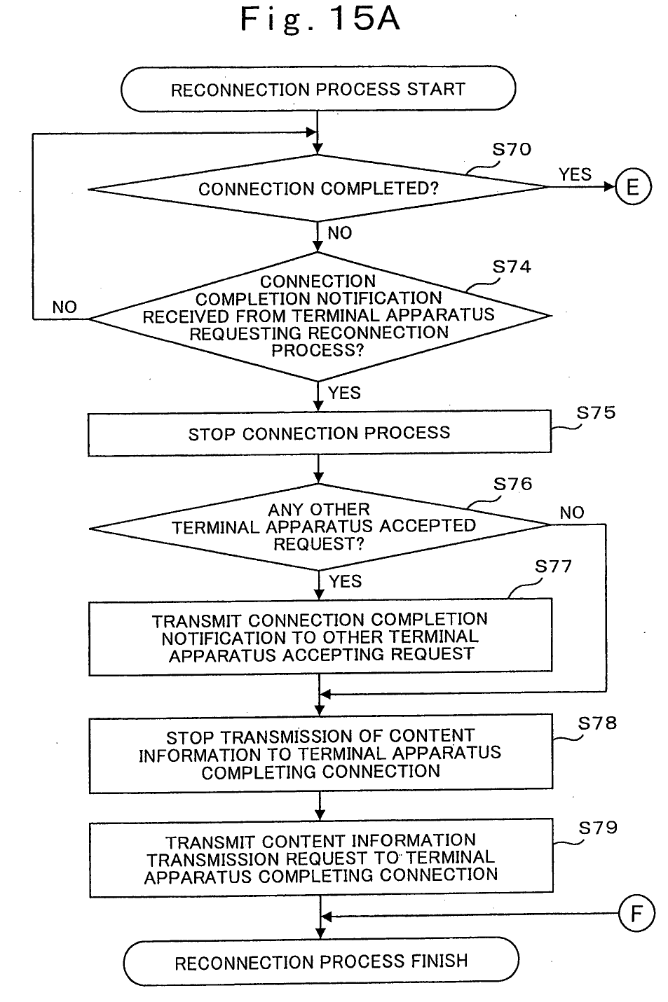

As shown in FIG. 3, in the case that the connection between the information distribution apparatus 1 and the terminal apparatus 2a1 is disconnected, the terminal apparatus 2a1, as well as detecting that the connection has been disconnected, using the connection condition detection module, and starting the connection process, as heretofore described, transmits a connection request message T1 to, among the downstream apparatus 2b1, 2b2, 2c1, 2c2 and 2c3, the downstream apparatus 2b1 and 2b2, which are directly connected to the terminal apparatus 2a1 itself, as shown in FIG. 13.

Herein, the terminal apparatus 2b1 and the terminal apparatus 2b2, which have received the connection request message T1, determine whether or not there is a capacity to connect an apparatus to the downstream of the apparatus itself and, if it is determined that there is a capacity to connect an apparatus to the downstream of the apparatus itself, start a connection process appropriate to the request, using the requested connection process module.

That is, in the case that the two terminal apparatus 2c1 and 2c2, constituting the upper limit connection quantity, are already connected to the downstream of the terminal apparatus 2b1, the terminal apparatus 2b1, using a determination module, determines that there is not the capacity to connect an apparatus to the downstream of the apparatus itself, transmits a request refusal message T5 to the terminal apparatus 2a1, as shown in FIG. 13, and does not carry out the connection process. Meanwhile, in the case that only the terminal apparatus 2c3 is connected to the downstream of the terminal apparatus 2b2, not exceeding the upper limit connection quantity, the terminal apparatus 2b2, using the determination module, determines that there is the capacity to connect an apparatus to the downstream of the apparatus itself, transmits a request acceptance message T2 to the terminal apparatus 2a1, and starts the connection process, using the requested connection process module.

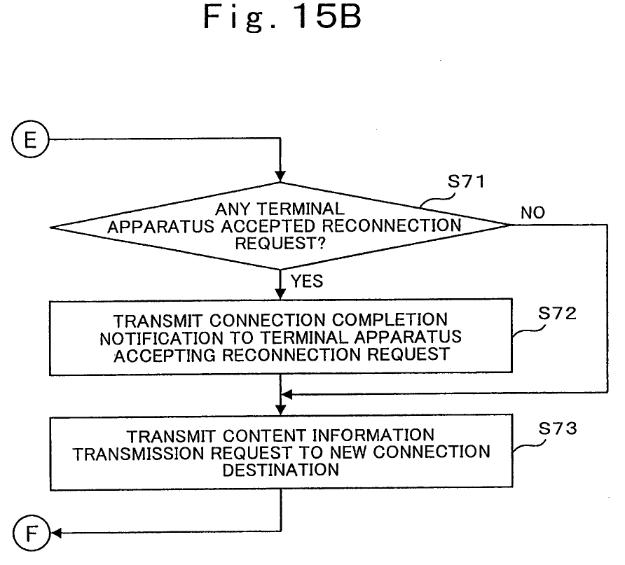

As a result thereof, in the case that the terminal apparatus 2b2 completes the connection process before the terminal apparatus 2a1, and becomes connected to the downstream of the terminal apparatus 2b3, the terminal apparatus 2b2 transmits a connection completion notification T3 to the terminal apparatus 2a1, as shown in FIG. 14. Then, the terminal apparatus 2a1, which has received the connection completion notification T3, receives content information, using the reception control module, with the terminal apparatus 2b2 as an upstream apparatus. That is, the terminal apparatus 2a1, which has originally been the upstream apparatus of the terminal apparatus 2b2, on receiving the connection completion notification T3 from the terminal apparatus 2b2, configures a sub-tree having the terminal apparatus 2b2 as an apex, by making a request to the terminal apparatus 2b2 for a transmission of content information.

In this way, with the information distribution system S′ according to the second embodiment, the terminal apparatus 2 starts the connection process appropriate to the request, using the requested connection process module, only when it determines, using the determination module, that there is the capacity to connect an apparatus to the downstream of the apparatus itself, meaning that it is possible to prevent a superfluous burden being imposed on the network due to a terminal apparatus with no connection capacity carrying out the connection process, as a result, a stable transmission and reception of content information become possible.

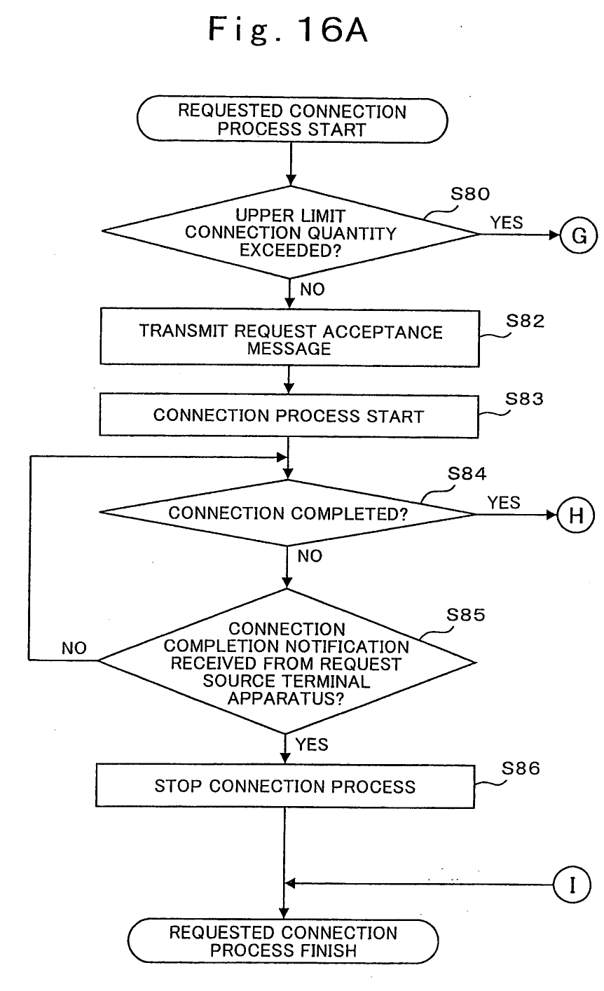

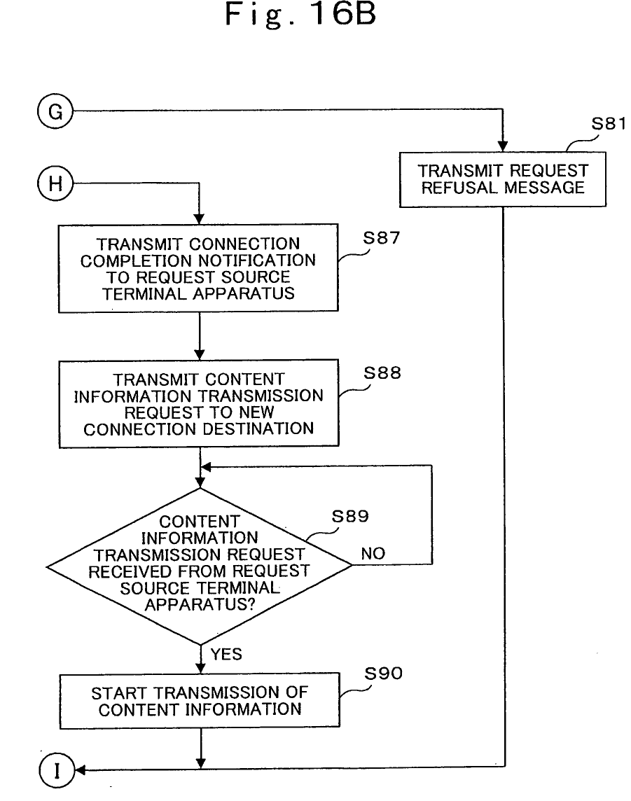

Hereafter, a more detailed description will be given of the operations of the information distribution system S′ according to the second embodiment. FIG. 15 is a flowchart of the reconnection process of the terminal apparatus 2 in the second embodiment, while FIG. 16 is a flowchart of the requested connection process of the terminal apparatus 2 in the second embodiment. The following processes are executed by the controller 101 of the terminal apparatus 2 functioning as each heretofore described module, and the like.

As shown in FIG. 15, on starting the reconnection process, the controller 101 determines whether or not the connection process is completed (step S70). If it is determined, in this process, that the connection process is completed (step S70: Yes), the controller 101 shifts the process to step S71.

In step S71, the controller 101 determines whether or not there exists a terminal apparatus 2 which has accepted the reconnection request. This determination is made based on whether or not a request acceptance message has been received from the downstream apparatus to which the connection request message has been transmitted. If it is determined, in this process, that there exists a terminal apparatus 2 which has accepted the reconnection request (step S71: Yes), the controller 101 transmits a connection completion notification to the terminal apparatus 2 which has accepted the reconnection request (step S72).

When the process of step S72 is finished, or alternatively when no terminal apparatus 2 which has accepted the reconnection request exists in step S71 (step S71: No), the controller 101 transmits a content information transmission request to an upstream apparatus which has newly become directly connected to its own terminal apparatus 2 (step S73).

Meanwhile when, in step S70, the connection process is not completed (step S70: No), the controller 101 determines whether or not a connection completion notification has been received from the downstream apparatus of which it has requested the reconnection process (step S74). When no connection completion notification has been received in this process (step S74: No), the controller 101 shifts the process to step S70.

Meanwhile, if it is determined, in step S74, that a connection completion notification has been received from the downstream apparatus of which it has requested the reconnection process (step S74: Yes), the controller 101 stops the connection process (step S75).

Next, the controller 101 determines whether or not there exists a terminal apparatus 2 which has accepted the reconnection request, other than the terminal apparatus 2 which has transmitted the connection completion notification (step S76) If it is determined, in this process, that there exists a terminal apparatus 2 which has accepted the reconnection request, other than the terminal apparatus 2 which has transmitted the connection completion notification (step S76: Yes), the controller 101 transmits a connection completion notification to that terminal apparatus 2 (step S77).

When finishing the process of step S77, or alternatively in step S76 when there exists no terminal apparatus 2 which has accepted the reconnection request, other than the terminal apparatus 2 which has transmitted the connection completion notification (step S76: No), the controller 101 stops the transmission of content information to the downstream apparatus which has completed the connection (step S78), and transmits a content information transmission request to the downstream apparatus which has completed the connection (step S79).

When finishing the processes of steps S73 and S79, the controller 101 finishes the reconnection process.

Next, a specific description will be given, referring to the flowchart of FIG. 16, of the requested connection process in the second embodiment. FIG. 16 is a flowchart of the requested connection process in the terminal apparatus 2.

As shown in FIG. 16, on starting the requested connection process, the controller 101 determines whether or not a quantity of the downstream apparatus directly connected to its own terminal apparatus 2 exceeds the upper limit connection quantity (step S80). If it is determined, in this process, that the quantity of the downstream apparatus directly connected to its own terminal apparatus 2 exceeds the upper limit connection quantity (step S80: Yes), the controller 101 transmits a request refusal notification to the request source terminal apparatus 2 (step S81). Meanwhile when, in step S80, the quantity of the downstream apparatus directly connected to its own terminal apparatus 2 does not exceed the upper limit connection quantity (step S80: No), the controller 101 transmits a connection completion notification to the request source terminal apparatus 2 (step S82).

Next, the controller 101 starts the connection process (step S83). The connection process is the same kind of process as step S11 in FIG. 9. The connection process is carried out until it is determined, instep S84, that the connection process is completed (step S84: Yes), or alternatively until the connection process is stopped in step S86.

Next, the controller 101 determines whether or not the connection process is completed (step S84). When, in this process, the connection process is not completed (step S84: No), the controller 101 determines whether or not it has received a connection completion notification from a request source terminal apparatus 2 (step S85). Then when, in this process, no connection completion notification has been received from a request source terminal apparatus 2 (step S85: No), the controller 101 shifts the process to step S84, while if it is determined that a connection completion notification has been received from a request source terminal apparatus 2 (step S85: Yes), the controller 101 stops the connection process (step S86).

Meanwhile, when it is determined, in step S84, that the connection process is completed (step S84: Yes), the controller 101 transmits a connection completion notification to the request source terminal apparatus 2 (step S87), and transmits a content information transmission request to a terminal apparatus 2 which has newly become an upstream apparatus directly connected to its own terminal apparatus 2 (step S88).

Next, the controller 101 determines whether or not it has received a content information transmission request from the request source terminal apparatus 2 (step S89) and, if it determines that it has received a content information transmission request from that terminal apparatus 2 (step S89: Yes), the controller 101 transmits content information to the terminal apparatus 2 (step S90).

When finishing the processes of steps S86 and S90, the controller 101 finishes the requested connection process.

The heretofore described preferred embodiments of the invention being disclosed for the purpose of illustration, those skilled in the art appertaining to the invention will be able to make various substitutions, modifications and changes, without departing from the scope of the technical idea of the invention, and these kinds of substitutions, changes and the like also appertain to the claims.

For example, although a description has been given with the IP address as an example of the location information of the terminal apparatus 2, it being sufficient that it is able to identify a position in the network, it is also acceptable to make it location information which includes a port number in addition to the IP address.

What is claimed is:

1. A terminal apparatus in an information distribution system in which a plurality of terminal apparatus are connected in multilayers on a network in a hierarchical structure, with an information distribution apparatus as an apex, and information distributed from the information distribution apparatus is sequentially relayed downstream in the hierarchical structure by a relay function of each of the terminal apparatus, enabling an acquisition of the information by the plurality of terminal apparatus, the terminal apparatus comprising:
a connection condition detection module which detects that it has become necessary to reconnect to another terminal apparatus different from an apparatus connected upstream in the hierarchical structure;
a connection process module which, on detecting that the reconnection has become necessary, starts a process of connecting to another terminal apparatus configuring the hierarchical structure;
a connection request module which, on detecting that the reconnection has become necessary, requests of an apparatus connected downstream in the hierarchical structure a process of connecting to another terminal apparatus configuring the hierarchical structure; and
a reception control module which, on the connection process of the apparatus connected downstream finishing before the connection process using the connection process module finishes, receives the information with the apparatus connected downstream as an upstream apparatus.

2. The terminal apparatus according to claim 1, wherein
the connection request module, when an average value of time for the connection process using the connection process module, taken in the past by a terminal apparatus for which the reconnection has become necessary, is equal to or greater than a predetermined value, makes a request for the connection process.

3. The terminal apparatus according to claim 1, wherein
the reception control module, on the connection process using the connection process module finishing after the connection process of the apparatus connected downstream finishes, switches the apparatus which receives the information from the apparatus connected downstream to the apparatus connected using the connection process module.

4. The terminal apparatus according to claim 1, further comprising:
a determination module which, on receiving the request for the connection process from another terminal apparatus, determines whether or not there is a capacity to connect an apparatus to the downstream of the apparatus itself; and
a requested connection process module which on determining, using the determination module, that there is a capacity to connect an apparatus to the downstream of the apparatus itself, starts a connection process appropriate to the request.

5. The terminal apparatus according to claim 1, wherein
the connection request module, in the case that the connection process using the connection process module finishes before the connection process of the apparatus connected downstream finishes, requests the apparatus connected downstream to stop the connection process.

6. A recording medium on which is recorded, in such a way as to be computer-readable, a program which causes a computer to function as each module according to claim 1.

7. A method of the process of reconnecting to a hierarchical structure in a terminal apparatus in an information distribution system in which a plurality of terminal apparatus are connected in multilayers on a network in a hierarchical structure, with an information distribution apparatus as an apex, and information distributed from the information distribution apparatus is sequentially relayed downstream in the hierarchical structure by a relay function of each of the terminal apparatus, enabling an acquisition of the information by the plurality of terminal apparatus, the method comprising:
a step of detecting that it has become necessary to reconnect to another terminal apparatus different from an apparatus connected upstream in the hierarchical structure;
a step of, on detecting that the reconnection has become necessary, starting a first connection process of carrying out a connection to another terminal apparatus configuring the hierarchical structure, and furthermore, requesting of an apparatus connected downstream a second connection process of carrying out a connection to another terminal apparatus configuring the hierarchical structure; and
a step of, when the second connection process of the apparatus connected downstream finishes before the connection process using the first connection process finishes, receiving the information with the apparatus connected downstream as an upstream apparatus.
